(19) United States
(12) Patent Application Publication
(10) Pub. No.: US 2022/0256892 A1
(43) Pub. Date: Aug. 18, 2022

(54) COMPLETE FOOD FOR AQUACULTURE ANIMALS FORMED FROM INSECT LARVAE

(71) Applicant: GENUFEED LTD., Ramat Gan (IL)

(72) Inventor: Yair M Fecher, Ramat Gan (IL)

(21) Appl. No.: 17/628,715

(22) PCT Filed: Jul. 22, 2020
(86) PCT No.: PCT/IL2020/050812

§ 371 Date: Jan. 20, 2022

Related U.S. Application Data
(60) Provisional application No. 62/876,794, filed on Jul. 22, 2019.

(51) Int. Cl. A23K 50/80; A23K 20/158; A23K 40/30

(52) U.S. Cl. CPC A23K 50/80; A23K 40/30; A23K 20/158

(57) ABSTRACT

The present invention provides food for aquaculture animals based on insect larvae which have been coated with a coating supplemented with nutrients that are not found in sufficient quantities in the insect larvae alone, and methods of producing same. The present invention further provides methods of using the food for aquaculture and aquarium feeding.

### FIELD OF THE INVENTION

The present invention relates to the field of feeding aquaculture and aquarium animals, particularly to an enriched food for fishes and crustaceans based on insect larvae coated with a coating containing supplementary nutrients and methods of producing same.

### BACKGROUND OF THE INVENTION

Aquaculture represents one of the fastest growing food producing sectors, providing a product that is an acceptable supplement and substitute to wild fish and other edible aquatic animals. The most commonly fish feed used in aquaculture and aquariums is extruded feed pellets. Commercial extruded fish feed pellets provide the fish with a complete diet containing the required nutrients for healthy development of the fish.

However, a main ingredient in extruded fish feed is fishmeal, unsustainably produced from large quantities of small pelagic fish caught in the wild.

The production process of fish feed pellets is capital intensive and lengthy, requiring a complex series of processes as well as highly experienced and skilled technicians to operate the production machinery.

Invertebrates have been portrayed as a novel source of high-quality protein that can be used in fish feed. Whole invertebrates may not contain all the nutrients and ingredients required for each fish or crustacean species in each developmental stage. However, invertebrates processed into protein-rich insect-meal is a sustainable alternative to fishmeal. Nevertheless, while insect meal is an alternative to fishmeal in fish feed production, the usage of insect-meal in fish feed depends on an additional process of refining the larvae into fat and protein. This is in addition to the already complex fish feed pellets extrusion process.

A main problem to be overcome with insect based food products is the need to supplement this food source with nutrients which are missing or in suboptimal levels to be useful for optimal complete feed for aquaculture. First and foremost is the need to supplement insect based food products with oil soluble nutrients including essential fatty acids, such as the omega-3 fatty acids.

Due to the large capital investment associated with setting up a fish feed extrusion facility, a high break-even point of annual sales is required in order to justify the large capital investment. As a result, fish farmers in regions with no fish feed extrusion facilities are forced to rely on expensive feed imports.

Attempts to use invertebrate larvae as a source for aquaculture animal feed have been made. For example, U.S. Pat. No. 6,303,175 discloses a gel-like feed for aquatic animals, especially fish, shrimps and invertebrates, in fresh and sea water, usable as replacement of frost feed for the nutrition of warm and cold water ornamental fish in an aquarium. The feed contains a gel former, natural feed source and water, and optionally further nutrient additives.

U.S. Application Publication No. 2004/0096543 discloses fish food comprising whole invertebrate organisms coated with a hydrocolloid suspension in aqueous phase, wherein hydrocolloid can be gelated.

U.S. Application Publication No. 20180000122 and U.S. Application Publication No. 20200221733 disclose micro-encapsulated aquaculture feed including an oil phase having an oil-soluble nutrient component; a water phase, which is present inside the oil phase, and which includes a water-soluble nutrient component; and a film, which includes the oil phase and the water phase. The water-soluble nutrient component includes at least one hydrolysate selected from hydrolysates of amino acids, oligopeptides, and proteins.

Presently, there is no solution for commercial production of complete insect-based fish food that does not include the refining and extraction of protein and fat from the insect as well as the capital-intensive and highly technical feed pellets extrusion process.

There is a need in the market for a sustainable, complete food for aquaculture-animal and methods of producing same, which may be available and affordable to the end users.

### SUMMARY OF THE INVENTION

The present invention provides a complete food product for aquatic animals, particularly fish or crustaceans, tailor-made for the species of the aquatic animal, its stage of development and environmental growing conditions. The present invention further provides a platform technology for producing the complete food product that can be performed by an end user without the need of sophisticated equipment and/or significant investments.

The complete food of the present invention is based on intact or chopped insect larvae enriched with all nutrients such as amino acids, fatty acids, vitamins, minerals and additional functional ingredients required for the aquatic animal growth, development and health, and missing from the larvae natural body components. The complete food of the invention can be produced by an end user by coating larvae with the nutrient compositions of the invention at the site of use. The teachings of the present invention are thus advantageous over hitherto known aquatic animal feed and methods of producing same at least in that the final product provides the aquatic animal with all its nutritional requirements; it is appealing to the consuming animal; it has no or minimal hazardous effects on the environment; and is economical.

According to one aspect, the present invention provides a food for aquatic animals comprising at least one species of insect larvae or a part thereof coated with solid or semi solid coating comprising a nutrient composition, the nutrient composition comprising an oil phase and at least one nutrient component enriching the nutritive value of the larvae.

According to certain embodiments, the at least one nutrient component is selected from the group consisting of oil-soluble nutrient, water soluble nutrient and a combination thereof. According to certain embodiments, the nutrient composition further comprises a water phase.

According to certain exemplary embodiments, the nutrient composition further comprises at least one food grade functional material forming a water-stable film coating.

According to these embodiments, the water-stable film coating at least partially encapsulates the insect larvae coated with the nutrient composition. The food grade functional material may interact with the oil phase to form the water-stable film coating or said material or a combination of said materials may form the water-stable film coating.

According to certain embodiments, the food grade functional material forming a water-stable film coating prevents leaching of the nutrient components and optionally further stabilizes the formulation of the nutrient composition. The functional material forming the film coating can be selected from a wax, an emulsifier, a polysaccharide, a protein, a resin and combinations thereof.

According to certain embodiments, the functional material forming the film coating is a wax, an emulsifier or a combination thereof.

In certain embodiments, the wax is a hard wax. In additional embodiments, the emulsifier is a solid emulsifier.

According to certain embodiments, the larvae are of a species selected from the group consisting of Black Soldier Fly (Hermetia illucens), Common Housefly (Musca domestica), Yellow Mealworm (Tenebrio molitor), Lesser Mealworm (Alphitobius diaperinus), House Cricket (Acheta domesticus), Banded Cricket (Gryllodes sigillatus) Field Cricket (Gryllus assimilis) or any other suitable insect species, and any combination thereof.

According to certain embodiments, the oil-soluble nutrient component is selected from the group consisting of a fatty acid, an oil-soluble vitamin, an oil-soluble nutritional mineral and any combination thereof.

According to certain exemplary embodiments, the fatty acid is selected from the group consisting of Eicosapentaenoic acid (EPA, omega 3), Docosahexaenoic acid (DHA, omega 3), and a combination thereof. It is to be explicitly understood that the fatty acid may be a component of the oil used to form the oil phase of the nutrient composition or it may be separately added to the nutrient composition.

According to certain exemplary embodiments, the oil-soluble vitamin is selected from the group consisting of vitamin E, vitamin K, vitamin D, vitamin A, and any combination thereof.

According to certain embodiments, the water-soluble component is selected from the group consisting of an amino acid, a water-soluble vitamin, a water soluble nutritional mineral and any combination thereof.

According to certain embodiments, the nutrient composition further comprises at least one aquatic-animal compatible ingredient selected from the group consisting of a palatability enhancer, a pigment, a preservative, an anti-oxidant and any combination thereof.

According to certain embodiments, the nutrient composition further comprises at least one aquatic-animal compatible medication.

According to certain embodiments, the nutrient composition further comprises at least one aquatic-animal compatible vaccine.

According to certain embodiments, the larvae are in a form selected from a live form and a dead form. According to certain embodiments, the dead larvae are partially or completely dried.

According to certain embodiments, the components of the nutrient composition and their ratios are set according to the aquatic animal species and/or growth stage.

According to yet additional aspect, the present invention provides a process for preparing a food for aquatic animal comprising at least one species of insect larvae, the process comprising:

a. obtaining at least one species of larvae separated from the larvae frass and/or any residual rearing substrate; and

b. coating the larvae with a solid or semi solid nutrient composition comprising an oil phase comprising at least one nutrient component and optionally a water phase.

The oil phase and nutrient components are as described hereinabove.

According to certain embodiments, said process further comprising adding at least one food grade functional material to form a water-stable film coating at least partially encapsulating the coated larvae.

According to certain embodiments, the larvae are obtained at a growth stage set by the chitin content of said larvae, wherein said chitin content is suitable for the aquatic animal to be fed.

According to certain embodiments, the process further comprises analyzing the nutritional content of the larvae. Analyzing the nutritional content of the larvae assists in setting the nutritional components to be added to the food, taking in account the species, size, and developmental stage of the aquatic animal to be fed.

According to certain embodiments, the step of obtaining the larvae comprises chopping or otherwise dividing the larvae to smaller parts.

According to certain embodiments, the process further comprises a step of sanitizing the obtained larvae to minimize the presence of pathogens on said larvae.

According to certain embodiments, the process further comprises drying the larvae. The larvae can be partially or completely dried.

According to certain embodiments, the process includes a pre-treatment of the larvae prior to coating that aims at enabling easier digestion of the larvae by certain species of aquatic animals. According to certain embodiments, the pre-retreatment comprises at least one of reducing the amount of chitin in the larvae, softening the larvae cuticle, and/or reducing the cuticle thickness without reducing the chitin content. The above-described pre-treatments can be performed by any method as is known in the Art.

According to certain embodiments, the chitin content is reduced by applying certain acids such as citric acid and acetic acid or by applying alkali such as caustic soda. Softening the cuticle may be achieved by heat treatment such as by applying hot air, steam, or hot water or by heating with microwave energy; by subjecting the larvae to cuticle softening enzymes; or by subjecting the larvae to microbial fermentation.

According to certain embodiments, the process further comprises drying the coated larvae.

According to yet additional aspect, the present invention provides a method of feeding an aquatic animal, the method comprises applying to the rearing water of the aquatic animal a nutritionally effective amount of the food of the present invention. The nutritionally effective amount will be set according to the aquatic animal species, size, developmental stage etc. as is known to a person skilled in the Art. According to some embodiments, the method comprises applying the food of the invention in combination with extruded feed pellets.

It is to be understood that any combination of each of the aspects and the embodiments disclosed herein is explicitly encompassed within the disclosure of the present invention.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the Art from this detailed description.

### BRIEF DESCRIPTION OF THE FIGURES

FIG. 1 is a schematic presentation of the encapsulated larvae.

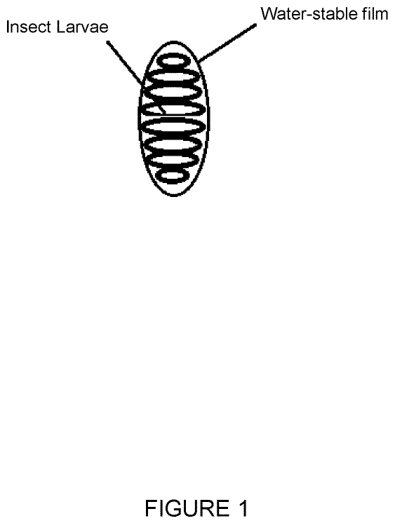

FIG. 2 is a flow chart showing the production of the food of the invention comprising larvae coated with nutrient composition and use thereof.

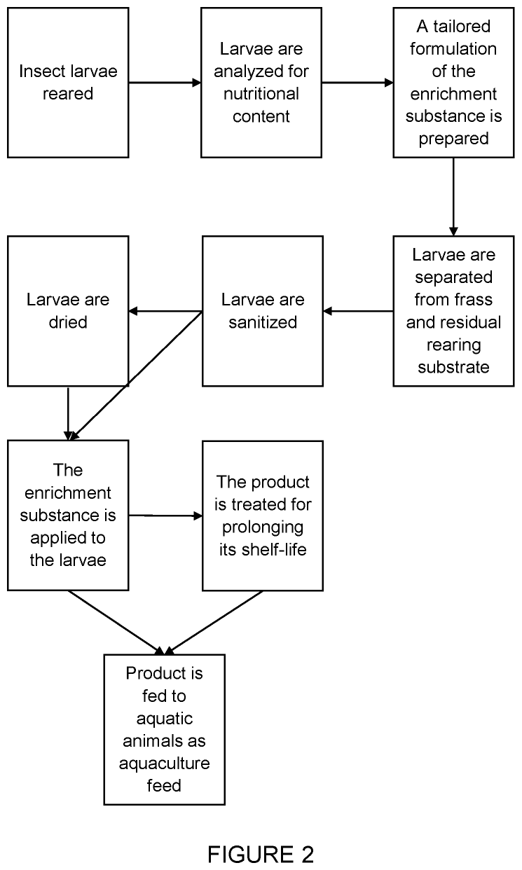

FIG. 3 shows the reduction in feed conversion ratio (FCR) in Rainbow Trout fish fed with the food of the invention comprising larvae coated with nutrient composition.

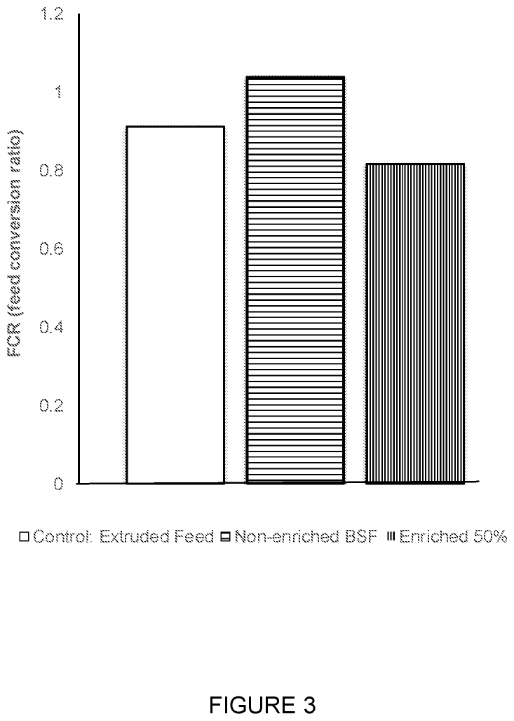

### DETAILED DESCRIPTION OF THE INVENTION

The present invention provides novel food for feeding aquaculture animals comprising whole or chopped invertebrate organisms, dead or alive, moist or dried, coated with an enrichment substance containing ingredients missing from the larvae body and required for optimal growth and health of aquaculture animals, particularly fish and crustaceans.

The terms “food” and “feed” are used herein interchangeably, and refer to a nutrition product or composition, particularly to nutrition product/composition suitable for feeding aquaculture animals.

Insect larvae, for example larvae of any one of Black Soldier Fly (Hermetia illucens), Common Housefly (Musca domestica), Yellow Mealworm (Tenebrio molitor), Lesser Mealworm (Alphitobius diaperinus), House Cricket (Acheta domesticus), Banded Cricket (Gryllodes sigillatus) Field Cricket (Gryllus assimilis) may be used as food for aquaculture animals, particularly fish. While known as a good protein source, the larva body does not contain all the ingredients required for an optimal growth and development, including reproduction, of aquatic animals.

Thus, according to an aspect of the present invention, there is provided a food for aquatic animals comprising at least one species of insect larvae or a part thereof coated with solid or semi solid coating comprising a nutrient composition, the nutrient composition comprising an oil phase and at least one nutrient component enriching the nutritive value of the larvae.

According to certain embodiments, a preferred process of manufacture of the food product according to the teachings of the invention comprises insect larvae that have been treated to minimize the presence of any pathogens, and the application of a specific tailor-made nutrient composition on the larvae by mixing with, spraying of or dipping the larvae in the coating nutrient composition.

The larvae used for the food of the present invention can be alive or dead. The dead larvae can be partially or completely dried. As used herein, the term “partially dried larvae” refers to larvae containing from about 40% to about 16% of water. The term “completely dried larvae” refers to larvae containing from about 15% to about 0% of water.

According to certain embodiments, the nutrient composition for coating the insect larvae is in a form selected from the group consisting of an oil in water emulsion, water in oil emulsion, an oleo-gel made of 100% of oily phase, all containing nutrient compounds as are known to a person skilled in the art and as described herein. Various method can be used for formulating the nutrient composition, as such methods are known in the art and as described herein.

In view of the expected use, the functional ingredients in the nutrient composition are food-safe.

A fish nutrition specialist can formulate the specific enrichment substance so that the nutrient composition contains, in the desired proportions, all ingredients that are missing from the insect larvae. The ingredients may include specific amino acids including, but not limited to, Methionine or Lysine; specific fatty acids including, but not limited to, Eicosapentaenoic acid (EPA, omega 3) and Docosahexaenoic acid (DHA, omega 3); any minerals including, for example, Calcium or Phosphorus; any oil-soluble vitamins including vitamin D, K, A and E, and optionally water-soluble vitamins; and any medications, vaccinations or functional materials such as flesh pigmentation additives such as Astaxanthin. The nutrient composition can further comprise proteins.

According to certain exemplary embodiments, the nutrient composition comprises EPA, DHA, or a combination thereof.

According to certain exemplary embodiments, the nutrient composition further contains a functional material that creates a water-stable film coating. According to further certain exemplary embodiments, the water-stable film coating is formed once the nutrient composition is applied to the insects.

As used herein, the term “water-stable film coating” refers to a film, or a thin layer, formed from food grade material(s) that prevents leaching of the nutrient components present in the nutrient composition of the invention into water immediately after placing the food in the water. The water-stable film coating is thus designed to prevent leaching for a period of time typical to the time lapse from applying a food portion to a plurality of aquatic animals until a significant part of the portion is consumed by the animals. The period of time in which leaching is prevented depends on the eating habits of the aquatic animals being fed, and, according to certain exemplary embodiments, range from a few minutes up to several hours.

According to some embodiments, the water-stable film coating is water-repelling. The formation of a water-stable film coating, at least partially encapsulating the larvae coated with the nutrient composition is a significant advantage of the food of the present invention, preventing loss of the enrichment materials leached into the water before being consumed by the aquaculture animal. Furthermore, preventing leaching of components of the food prevents contamination of the aquaculture rearing water.

The water-stable film coating which prevents the leaching of the nutrient components into the water may be created by using food-safe ingredients that provide such utility. According to some embodiments, the functional material forming the water-stable film coating is selected from the group consisting of a wax, an emulsifier, and combinations thereof. In certain embodiments, the wax is a hard wax. In additional embodiments, the emulsifier is a solid emulsifier.

According to certain exemplary embodiments, the functional material forming the water-stable film coating is a wax. Examples include, but are not limited to beeswax, carnauba wax, jojoba oil, Candelilla wax, rice bran wax and combinations thereof.

According to some embodiments, the wax is present in the nutrient composition in a weight percent ranging from about 1 to about 45% wt. According to some embodiments, the wax is present in the nutrient composition in a weight percent ranging from about 1 to about 10% wt. According to some embodiments, the solid emulsifier is present in the nutrient composition in a weight percent ranging from about 1 to about 15% wt.

According to certain exemplary embodiments, the nutrient composition comprises a lipid phase and a water phase. An advantage of a nutrient composition comprising both an oil phase and a water phase is in the option to include both water soluble nutritional ingredients such as certain amino acids as well as fat soluble nutritional ingredients such as certain fatty acids.

The nutrient component, whether oil-soluble or water-soluble, can be in a form of a liquid, a solid, a gel and the like. Solid components can be in a form of a dry powder, granules, or particles of various sizes. According to certain embodiments, the nutrient components are dispersed in the oil phase.

According to certain embodiments, the nutrient composition of the invention may further comprise at least one food grade surfactant and/or emulsifier for even distribution of the oily phase. According to certain embodiment, emulsifiers are selected from the group consisting of, but not limited to, polysorbate emulsifiers, polyglycerol esters of fatty acids, sucrose esters of fatty acids, sodium stearoyl lactylate, mono and di glycerides of fatty acids, lecithin and combinations thereof.

The presence of heavy metals in aquatic animal food is undesirable. According to certain embodiments, the nutrient composition further contains a chelating agent for controlling metals which accelerate oil oxidation. Examples of such chelating agents include, but are not limited to, Ethylenediaminetetraacetic acid (EDTA), disodium EDTA, calcium disodium EDTA and phytic acid.

According to certain embodiment, the nutrient composition contains functional ingredients that prolong the shelf life of the food product comprising the insect larvae. Alternatively, the larvae are processed by a method that prolongs the larvae's shelf life.

According to certain exemplary embodiments, the insect larvae and/or the nutrient composition comprises at least one food grade preservative. According to some embodiments, the preservative is selected from the group consisting of, but not limited to, sorbic acid or its salt, benzoic acid or its salt, ethylparaben, propylparaben, sulfur dioxide, sodium bisulfate, nisin, organic acids, e, g., anisic acid, and any combination thereof.

According to certain embodiments, the nutrient composition further comprises at least one food grade antioxidant to prevent oxidation. Examples antioxidants that can be used in the compositions of the invention include, but are not limited to, ascorbic acid or its salts, vitamin E (tocopherol) and its derivatives, propyl gallate, phytic extracts, rosemary extracts and any combination thereof.

According to certain exemplary embodiments, the nutrient composition further comprises at least binding agent that further stabilizes the formulation of the nutrient composition. According to certain embodiments, the binding agent is added when the nutrient composition is formulated as an oil-in-water or water-in-oil emulsion.

According to some embodiments, the binding agent is a polysaccharide. According to certain exemplary embodiments, the polysaccharide is selected from the group consisting of, but not limited to, starches, processed starches, carrageenans, pectins, alginates, guar gum, xanthan gum, mannan, cellulose derivatives, agar, gellan gum, chitin, chitosan, pullulan, locust bean gum, arabinogalactan and any combination thereof.

According to some embodiments, the binding agent is a resin. According to certain embodiments, the resin is selected from the group consisting of, but not limited to, gum arabic, mesquite gum, tragacanth gum, shellac and any combination thereof.

According to some embodiments, the binding agent is an emulsifier. According to certain embodiments, the emulsified is selected from the group consisting of, but not limited to, sucrose esters, mono and di glycerides of fatty acids, polyglycerol esters, fatty acids and combination thereof. According to certain exemplary embodiments the fatty acids are selected from stearic acid, palmitic acid, lauric acid and any combination thereof. In certain embodiments, the emulsifier is a solid emulsifier.

According to some embodiments, the binding agent is a protein. Examples include, but are not limited to, gelatin, soy protein, gluten, pea protein, sesame seed protein and the like.

The binding agent can be present in the nutrient composition in a weight percent ranging from about 2 to about 50% wt. According to some embodiments, the binding agent is present in the nutrient composition in a weight percent ranging from about 2 to about 40% wt. According to further embodiments, the binding agent is present in the nutrient composition in a weight percent ranging from about 5 to about 30% wt. According to still further embodiments, the binding agent is present in the nutrient composition in a weight percent ranging from about 5 to about 25% wt.

Any combination of the binding agents described hereinabove can be used.

The nutrient composition may be applied on the larvae, preferably by the user, with relative ease in comparison to the long, complex process of extruded fish feed pellets production.

The invertebrates which are concerned by the invention are generally of a size that meets the general eating habits of fish and crustaceans and is of similar size to the size range of commonly produced fish feed pellets.

In the case of larger fish that feed on pellets larger than the size of insects used in this invention, groups of more than one insect can be agglomerated together in order to create a large enriched cluster of insects to meet the fish's eating habits.

The process can also be used to manufacture a product attractive to fishes which can be designed to float, to settle to the bottom, sink to the bottom slowly or to be maintained by a float within the water.

Using the food of the invention comprising insect larvae and an enrichment nutrient composition to feed the aquaculture animal can be done by manual feeding or using automatic mechanical solutions as done with fish feed pellets.

An important feature of the present process and of the food product according to the invention is to proceed with whole or chopped invertebrate organisms sufficiently recognizable to have the aquaculture animal, particularly fishes, identifying the food as the invertebrates themselves. The natural appearance of the larvae in the food of the invention is preserved, and this is very attractive to the fish.

The teachings of the present invention may be further adapted to use adult stages of insects or other invertebrate organism that may be suitable as food for aquatic animals.

According to certain aspects, the present invention provides a food for aquatic animal comprising at least one species of an invertebrate organism or a part thereof coated with solid or semi-solid coating comprising a nutrient composition, the nutrient composition comprising an oil phase and at least one nutrient component enriching the nutritive value of the larvae.

The invertebrate organism can be an adult stage of a species of the larva described herein or any other invertebrate organism suitable as a food for aquaculture animals. The components of the food are as described herein.

An additional advantage of the invention is the minimal use of starch materials as a gluing or binding material in the formulation of the nutrient composition. In the production process of extruded fish feed pellets, manufacturers often use gluing starch materials such as corn starch, wheat starch or grinded wheat. This is being done in order to keep the different ingredients glued together; however, these gluing materials are hardly digestible by the fish and often end up polluting the rearing waters through the fish excrements. To the contrary, the larva body occupies the majority of each food particle of the present invention, and binding material in general, and starch material in particular, are only used in small amounts, contributing to the formulation of the nutrient composition.

Despite the usage of starch gluing materials, extruded fish feed pellets often crumble down to small particles and dust that pollute the rearing water and cause feed wastage. This occurrence is not common in the food product comprising encapsulated insect larvae of the invention.

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### EXAMPLES

### Example 1: Production of Larvae Coated with Fat-Soluble Enrichment Material

Suitable larvae to be used include larvae of Black Soldier Fly (Hermetia illucens), Common Housefly (Musca domestica), Yellow Mealworm (Tenebrio molitor), Lesser Mealworm (Alphitobius diaperinus), House Cricket (Acheta domesticus), Banded Cricket (Gryllodes sigillatus) and Field Cricket (Gryllus assimilis) or any other invertebrate larvae with a desired nutritional composition that can be used and enriched.

Insect larvae are reared under certain conditions and on certain substrate that cause them to contain a desired nutritional content of protein and fat and other elements. The larvae are harvested at a certain stage of their development, depending on the insect species and the aquaculture animal species to be feed. For feeding certain species of fish, the larvae are harvested before the chitin level in the larvae rises above the desired level for feeding the fish. The larvae are separated from the frass and/or any residual rearing substrate by a motorized sieving machine or by manual sieving. The larvae are sanitized to minimize the presence of pathogens by heating using microwave energy, blanching in hot water, steam or hot air that bring the temperature of the larvae above 72° C. for 40 seconds or by any other sanitation method. The larvae are then cut to smaller pieces if desired, kept intact as a single larva or as a stack of a plurality of larvae and coated with the enrichment substance. The coating process is done by spraying, dipping or tumbling in a rotating drum. The enrichment material is based on an oil-phase only and contains certain fatty acids such as EPA and DHA, powdered amino acids, vitamins and minerals premix uniformly dispersed in the enrichment material, vitamin E as a preservative and anti-oxidant and Candelilla wax as a food-safe water-stable and film coating agent. The enrichment material is prepared by heating the different materials to a temperature not exceeding 70° C. in order to prevent any damage to the ingredients or to prevent damaging any nutrient.

### Example 2: Production of Larvae Coated with Fat-Soluble and Water-Soluble Enrichment Material

Example 1 is repeated except that the enrichment material comprises a water-phase and a fat-phase, allowing enrichment of the larvae not only with fat soluble materials but also with water soluble materials such as certain amino acids dissolved in water, certain vitamins and other water-soluble ingredients. A material with a hydrophilic end and a hydrophobic end is added as an emulsifier that binds together the two phases into a uniform substance. A waterproofing material such as waxes and oleogels that is compatible with emulsions is used.

### Example 3: Optional Ingredients of the Enrichment Material

The process of Example 1 or Example 2 is repeated except the enrichment material contains functional ingredients such as Astaxanthin for flesh pigmentation.

The process of Example 1 or Example 2 is repeated except an attractant such as Lysine or Betaine or any other attractant is added in order to improve the palatability of the product.

The process of Example 1 or Example 2 is repeated except the enrichment material contains medications or vaccinations.

The process of Example 1 or Example 2 is repeated except the invertebrates are kept alive in order to increase their appeal to the fish.

The process of Example 1 or Example 2 is repeated except the larvae is harvested in a later development stage when chitin levels increase. This is being done for the purpose of feeding species such as prawns for which high levels of chitin are digestible and beneficial.

### Example 4: Exemplary Formulations

Exemplary formulations of nutrient composition according to the teachings of the invention and according to Examples 1-3 hereinabove are presented in Tables 1-2 below.

TABLE 1
Formulation of the nutrient composition in the form of Oleogel

| Ingredient | Quantity % |
|---|---|
| Fish oil/Algal oil | 84 |
| Glyceryl monostearate 40% (GMS 40%) | 7 |
| Beeswax (Cera Alba) (Kahl GmbH & Co. | 3 |
| KG, Germany) | |
| Encapsulated amino acids (Kemin | 5 |
| Industries, Inc., USA) | |
| Tocopherol | 1 |
| Total | 100 |

TABLE 2
Formulation of the nutrient composition in the form
of oil-in-water emulsion
Table 2: The pH of the nutrient composition is 4.5

| Ingredient | Quantity % |
|---|---|
| Fish oil/Algal oil | 37.3 |
| Polysorbate 60 | 6 |
| Glyceryl Monostearate 90% | 5 |
| Bees Wax (Cera Alba) (Kahl GmbH & | 2 |
| Co. KG, Germany) | |
| Water | 34.6 |
| Glycerin | 8 |
| Sodium Benzoate | 0.1 |
| Potassium Sorbate | 0.2 |
| Anisic Acid | 0.1 |
| Amino acids (Adisseo) | 5 |
| Lactic acid 90% | 0.5 |
| Tocopherol | 1.0 |
| Tetrasodium EDTA | 0.2 |
| Total | 100 |

### Example 4: Feeding Trial

A rainbow trout feed trial was conducted between January and March of 2020 in the fish lab of “Dan Fish Farms” in Israel. Nine fish tanks, stocked with thirty juvenile rainbow trout each, were divided into 3 treatment groups:
1. A control treatment group of three tanks stocked with 30 rainbow trout juveniles each, were fed high-quality commercially extruded fish feed pellets containing 42% protein and 18% fat.
2. A treatment group of three tanks stocked with 30 rainbow trout juveniles each, were fed unenriched natural Black Soldier Fly larvae.
3. A treatment group of three tanks stocked with 30 rainbow trout juveniles each, were fed a diet comprising 50% extruded feed similar to the control group and 50% enriched BSF larvae which were treated with the food product of the invention comprising Black Soldier Fly larvae coated with a nutrient composition composed of the following materials: an oil with a fatty acid composition of more than 20% Eicosapentaenoic acid (EPA, omega 3) and Docosahexaenoic acid (DHA, omega 3); Bees-wax; Biotin, Inositol, Folic acid, Pantothenic acid, Para aminobenzoic Acid, Choline, Niacin, Vitamin B1, B2, B6, B12, Vitamin A, Vitamin E, Vitamin C, Vitamin K, Vitamin D3; Trace minerals: Iron, Calcium, Manganese, Copper, Zinc; and Polydimethylsiloxane.

The starting fish biomass in each of the 9 tanks was similar. The fish in all tanks were fed the same amount of feed on a dry matter basis. The fish were weighed once every two weeks and the daily feed ration was calculated as 2.5% of total biomass.

At the end of the trial, the biomass of each of the 9 tanks was weighed and Feed Conversion Rate (FCR) was calculated. FCR is a rate measuring of the efficiency with which the bodies of livestock convert animal feed into the desired output.

The FCR of the control group was 0.912

The FCR of the group of tanks that was fed whole untreated and unenriched Black Soldier Fly larvae was 1.04

The FCR of the group of tanks that was fed a diet comprising 50% extruded feed similar to the control group and 50% food product comprising BSF larvae and the enrichment nutrient composition described above, was 0.817 (the best performing group).

The results were consistent among different tanks of the same treatment group.

The results of the trial demonstrate the efficacy of the enrichment food product of the invention, proving that the food product leads to at least similar, and even superior performance in comparison with the state of the art (extruded fish feed pellets).

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

1-28. (canceled)

29. A food for aquatic animals, the food comprising:
at least one species of insect larvae or a part thereof coated with solid or semi solid coating comprising a nutrient composition;
wherein the nutrient composition comprises an oil phase and at least one nutrient component enriching a nutritive value of the larvae.

30. The food of claim 29, wherein the at least one nutrient component is selected from the group consisting of oil-soluble nutrient, water soluble nutrient, and a combination thereof.

31. The food of claim 30, wherein the nutrient composition further comprises a water phase.

32. The food of claim 29, wherein the nutrient composition further comprises at least one food grade functional material forming a water-stable film coating.

33. The food of claim 32, wherein the at least one food grade functional material forming the water-stable film coating is selected from the group consisting of a wax, an emulsifier, a polysaccharide, a protein, a resin, and any combination thereof.

34. The food of claim 32, wherein the water-stable film coating at least partially encapsulates the insect larvae coated with the nutrient composition.

35. The food of claim 29, wherein the larvae are of a species selected from the group consisting of Black Soldier Fly (Hermetia illucens), Common Housefly (Musca domestica), Yellow Mealworm (Tenebrio molitor), Lesser Mealworm (Alphitobius diaperinus), House Cricket (Acheta domesticus), Banded Cricket (Gryllodes sigillatus) Field Cricket (Gryllus assimilis), and any combination thereof.

36. The food of claim 30, wherein the oil-soluble nutrient component is selected from the group consisting of a fatty acid, an oil-soluble vitamin, and a combination thereof.

37. The food of claim 36, wherein the fatty acid is selected from the group consisting of EPA, DHA, and a combination thereof.

38. The food of claim 36, wherein the vitamin is selected from the group consisting of vitamin E, vitamin K, vitamin D, vitamin A, and any combination thereof.

39. The food of claim 30, wherein the water-soluble component is selected from the group consisting of an amino acid, a water-soluble vitamin, a nutritional mineral, and any combination thereof.

40. The food of claim 29, wherein the nutrient composition further comprises at least one aquatic-animal compatible ingredient selected from the group consisting of a palatability enhancer, a pigment, a preservative, and an anti-oxidant.

41. The food of claim 29 wherein the nutrient composition further comprises an agent selected from a medication and a vaccine.

42. The food of claim 29, wherein the larvae are in a form selected from a live form and a dead form.

43. The food of claim 42, wherein the dead larvae are partially or completely dried.

44. The food of claim 29, wherein the components of the nutrient composition and their ratios are set according to the aquatic animal species and/or growth stage.

45. A process for preparing a food for aquatic animal comprising at least one species of insect larvae, the process comprising:
obtaining at least one species of larvae separated from the larvae frass and/or any residual rearing substrate; and
coating the larvae with a solid or semi-solid nutrient composition comprising an oil phase comprising at least one nutrient component, and optionally a water phase.

46. The process of claim 45, wherein the at least one nutrient component is selected from the group consisting of an oil-soluble nutrient, a water-soluble nutrient, and a combination thereof.

47. The process of claim 45, further comprising adding at least one food grade functional material to form a water-stable film coating at least partially encapsulating the coated larvae.

48. A method of feeding an aquatic animal, the method comprising:
providing to the aquatic animal rearing water a nutritionally effective amount of the food according to claim 29.

49. The method of claim 48, further comprising providing the food in combination with extruded feed pellets.
